(19) United States
(12) Patent Application Publication
(10) Pub. No.: US 2020/0092757 A1
(43) Pub. Date: Mar. 19, 2020

(54) Method and Apparatus for Reducing a Service Interruption Time Within a Single-Cell Point-to-Multipoint System

(71) Applicant: Nokia Solutions and Networks Oy, Espoo (FI)

(72) Inventors: Xiang Xu, Nanjing, Jiangsu (CN); David Navratil, Helsinki (FI); Manivannan Thyagarajan, Coppell, TX (US)

(21) Appl. No.: 15/746,926

(22) PCT Filed: Aug. 13, 2015
(86) PCT No.: PCT/US2015/045106

§ 371 Date: Jan. 23, 2018

(51) Int. Cl. H04W 36/00; H04W 36/08

(52) U.S. Cl. CPC H04W 36/0007; H04W 36/08; H04W 36/0061

(57) ABSTRACT

A method and apparatus may include transmitting a single-cell point-to-multipoint information request to a network node. The single-cell point-to-multipoint information request indicates a first service is provided by the network node. The method may include receiving a single-cell point-to-multipoint information response. The single-cell point-to-multipoint information response indicates whether the first service is provided by the network node. The method may also include transmitting a first message to user equipment. The first message indicates to the user equipment whether or not the first service is provided by the network node.

### BACKGROUND

### Field

Embodiments of the present invention relate to reducing a service interruption time within a single-cell point-to-multipoint system.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include transmitting, by a first network node, a single-cell point-to-multipoint information request to a second network node. The single-cell point-to-multipoint information request indicates a first service is provided by the first network node. The method may also include receiving a single-cell point-to-multipoint information response. The single-cell point-to-multipoint information response indicates whether the first service is provided by the second network node. The method may also include transmitting a first message to user equipment. The first message indicates to the user equipment whether or not the first service is provided by the second network node.

In the method of the first embodiment, the first network node may include a first base station. The second network node may include a second base station. A first cell of the first base station is neighbor to a second cell of the second base station. The user equipment may be in mobility from the first cell to the second cell.

In the method of the first embodiment, the method may also include receiving a single-cell point-to-multipoint information update. The single-cell point-to-multipoint information update indicates whether a second service is provided by the second network node. The method may also include transmitting a second message to the user equipment. The second message indicates to the user equipment whether or not the second service is provided by the second network node.

In the method of the first embodiment, the single-cell point-to-multipoint information request, the single-cell point-to-multipoint information response, the single-cell point-to-multipoint information update, the first message, and the second message may include a list of temporary mobile group identities or a bitmap.

In the method of the first embodiment, the single-cell point-to-multipoint information response indicates whether a third service, which was not indicated in the point-to-multipoint information request as provided by the first network node, is provided by the second network node.

According to a second embodiment, an apparatus may include at least one processor. The apparatus may also include at least one memory including computer program code. The at least one memory and the computer program code may be configured, with the at least one processor, to cause the apparatus at least to transmit a single-cell point-to-multipoint information request to a network node. The single-cell point-to-multipoint information request indicates a first service is provided by the apparatus. The apparatus may also be caused to receive a single-cell point-to-multipoint information response. The single-cell point-to-multipoint information response indicates whether the first service is provided by the network node. The apparatus may also be caused to transmit a first message to user equipment. The first message indicates to the user equipment whether or not the first service is provided by the network node.

In the apparatus of the second embodiment, the apparatus may include a first base station. The network node may include a second base station. A first cell of the first base station is neighbor to a second cell of the second base station. The user equipment is in mobility from the first cell to the second cell.

In the apparatus of the second embodiment, the apparatus may be further caused to receive a single-cell point-to-multipoint information update. The single-cell point-to-multipoint information update indicates whether a second service is provided by the network node. The apparatus may also be caused to transmit a second message to the user equipment. The second message indicates to the user equipment whether or not the second service is provided by the network node.

In the apparatus of the second embodiment, the single-cell point-to-multipoint information request, the single-cell point-to-multipoint information response, the single-cell point-to-multipoint information update, the first message, and the second message may include a list of temporary mobile group identities or a bitmap.

In the apparatus of the second embodiment, the single-cell point-to-multipoint information response indicates whether a third service, which was not indicated in the point-to-multipoint information request as provided by the apparatus, is provided by the network node.

According to a third embodiment, a computer program product may be embodied on a non-transitory computer readable medium. The computer program product may be configured to control a processor to perform a method according to the first embodiment.

According to a fourth embodiment, a method may include receiving, by a second network node, a single-cell point-to-multipoint information request from a first network node. The single-cell point-to-multipoint information request indicates a first service is provided by the first network node. The method may also include transmitting a single-cell point-to-multipoint information response. The single-cell point-to-multipoint information response indicates whether the first service is provided by the second network node.

In the method of the fourth embodiment, the first network node includes a first base station. The second network node includes a second base station. A first cell of the first base station is neighbor to a second cell of the second base station. The user equipment is in mobility from the first cell to the second cell.

In the method of the fourth embodiment, the method may also include transmitting a single-cell point-to-multipoint information update. The single-cell point-to-multipoint information update indicates whether a second service is provided by the second network node.

In the method of the fourth embodiment, the single-cell point-to-multipoint information request, the single-cell point-to-multipoint information response, the single-cell point-to-multipoint information update, the first message, and the second message may include a list of temporary mobile group identities or a bitmap.

In the method of the fourth embodiment, the single-cell point-to-multipoint information response indicates whether a third service, which was not indicated in the point-to-multipoint information request as provided by the first network node, is provided by the second network node.

According to a fifth embodiment, an apparatus may include at least one processor. The apparatus may also include at least one memory including computer program code. The at least one memory and the computer program code may be configured, with the at least one processor, to cause the apparatus at least to receive a single-cell point-to-multipoint information request from a network node. The single-cell point-to-multipoint information request indicates a first service is provided by the network node. The apparatus may also be caused to transmit a single-cell point-to-multipoint information response. The single-cell point-to-multipoint information response indicates whether the first service is provided by the apparatus.

In the apparatus of the fifth embodiment, the network node may include a first base station. The apparatus may include a second base station. A first cell of the first base station is neighbor to a second cell of the second base station. The user equipment may be in mobility from the first cell to the second cell.

In the apparatus of the fifth embodiment, the apparatus may be further caused to transmit a single-cell point-to-multipoint information update. The single-cell point-to-multipoint information update may indicate whether a second service is provided by the apparatus.

In the apparatus of the fifth embodiment, the single-cell point-to-multipoint information request, the single-cell point-to-multipoint information response, the single-cell point-to-multipoint information update, the first message, and the second message may include a list of temporary mobile group identities or a bitmap.

In the apparatus of the fifth embodiment, the single-cell point-to-multipoint information response indicates whether a third service, which was not indicated in the point-to-multipoint information request as provided by the network node, is provided by the apparatus.

According to a sixth embodiment, a computer program product may be embodied on a non-transitory computer readable medium. The computer program product may be configured to control a processor to perform a method according to the fourth embodiment.

According to a seventh embodiment, an apparatus may include a first transmitting means that transmits a single-cell point-to-multipoint information request to a network node. The single-cell point-to-multipoint information request indicates a first service is provided by the network node. The apparatus may also include a receiving means that receives a single-cell point-to-multipoint information response. The single-cell point-to-multipoint information response indicates whether the first service is provided by the network node. The apparatus may also include a second transmitting means that transmits a first message to user equipment. The first message indicates to the user equipment whether or not the first service is provided by the network node.

According to an eighth embodiment, an apparatus may include a receiving means that receives a single-cell point-to-multipoint information request from a network node. The single-cell point-to-multipoint information request indicates a first service is provided by the apparatus. The apparatus may also include transmitting means that transmits a single-cell point-to-multipoint information response. The single-cell point-to-multipoint information response indicates whether the first service is provided by the apparatus.

### BRIEF DESCRIPTION OF THE DRAWINGS

For proper understanding of the invention, reference should be made to the accompanying drawings, wherein:

FIG. 1 illustrates high-level procedures for Single-Cell Point-to-Multipoint.

FIG. 2 illustrates an example implementation of certain embodiments of the present invention.

FIG. 3 illustrates a flowchart of a method in accordance with certain embodiments of the invention.

FIG. 4 illustrates a flowchart of a method in accordance with certain embodiments of the invention.

FIG. 5 illustrates an apparatus in accordance with certain embodiments of the invention.

FIG. 6 illustrates an apparatus in accordance with certain embodiments of the invention.

FIG. 7 illustrates an apparatus in accordance with certain embodiments of the invention.

### DETAILED DESCRIPTION:

Certain embodiments of the present invention relate to reducing a service interruption time within a single-cell point-to-multipoint system. Specifically, certain embodiments of the present invention may be used in conjunction with Single-Cell Point-to-Multipoint (SC-PTM) technologies, as described in 3GPP Release 13 Work Item RP-151110.

With regard to SC-PTM, when a core network (CN) initiates a Multimedia Broadcast Multicast Service (MBMS) Session Start procedure, the CN may include one or more cells in a MBMS SESSION START REQUEST message. Upon the reception of the MBMS SESSION START REQUEST message, a multi-cell/multicast coordination entity (MCE) can determine whether to use multicast-broadcast single-frequency network (MBSFN) transmissions, or whether to use SC-PTM transmissions.

If SC-PTM transmissions are used by the MCE, the MBMS service is generally only transmitted over the air interface in some cells of an MBSFN area, rather than in all cells of the MBSFN area. As such, even though some evolved Node Bs (eNBs) may possibly be within a same MBMS Service Area (or may even belong to a same MBSFN area), a specific MBMS service may possibly be only transmitted/provided in a few cells via SC-PTM, and the specific MBMS service may possibly not be provided in the neighbouring cells of the few cells.

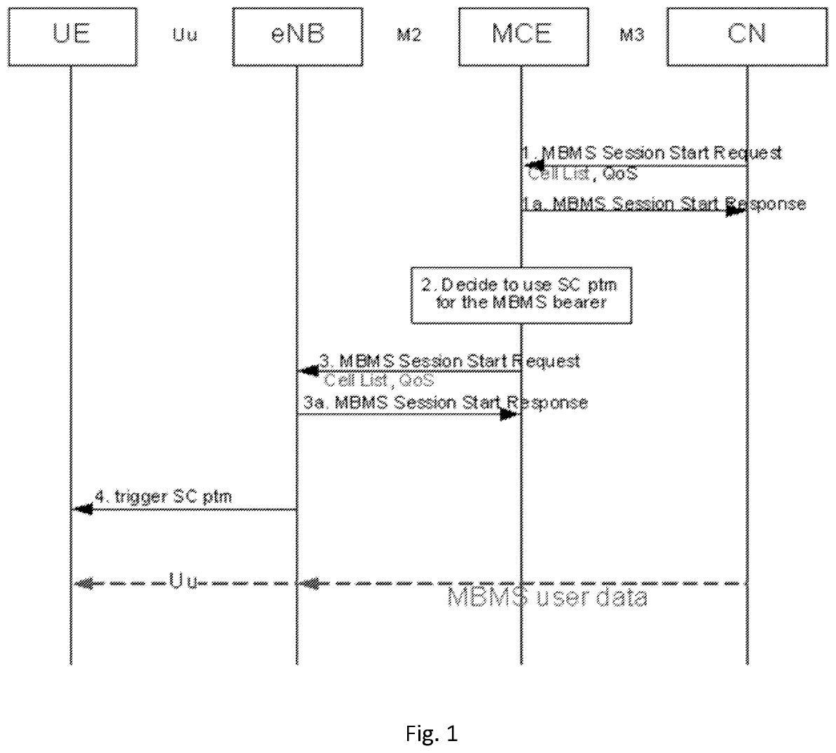

FIG. 1 illustrates high-level procedures of SC-PTM. With regard to service continuity in SC-PTM, one of the objectives that is described within the work item is described below:
“3) Specify necessary solutions to support service continuity when the UE moves between the cells where SC-PTM transmission is available or when the UE moves from the cell where SC-PTM transmission is available to the cell where it is not (i.e. via unicast), if the solution doesn't significantly impact the radio efficiency and signaling overhead. Afterwards, as a second priority if time permits, solution to support service continuity for UEs in RRC_IDLE may be identified and considered for specification. [RAN2, RAN3]”

During the study item phase, RAN2 discussed two possible scenarios. A first scenario corresponds to when a UE moves from a source cell where SC-PTM transmission is available, to a target cell where SC-PTM transmission is also available. Users that receive a group call over SC-PTM in the source cell will want the target cell to also provide the same group call over SC-PTM. The mobility of the users from the source cell (using SC-PTM) to the target cell (which also uses SC-PTM) will generally result in an interruption due to acquisition of SC-PTM configuration information in the target cell. The estimated average interruption time is 100 ms. The worst interruption time is about 180 ms. An interruption corresponding to 100 ms-180 ms interruption is likely acceptable and/or not noticeable by the end user, which results in seamless service continuity.

The second scenario corresponds to when the UE moves from a source cell where SC-PTM transmission is available, to a target cell where only unicast transmission is available. Users that receive a group call over SC-PTM in the source cell will want the target cell to also provide the same group call over SC-PTM. However, the service corresponding to the group call is not provided by the target cell using SC-PTM and users need to request the group call to be provided over unicast. For an IDLE UE (i.e., a UE in RRC IDLE state), the estimated average interruption time resulting from UE mobility from SC-PTM to unicast is approximately 220-350 ms. The worst interruption time is about 220-430 ms. For a CONNECTED UE (i.e., a UE in RRC CONNECTED state), the estimated average interruption time for mobility from SC-PTM to unicast is about 170 ms. The worst interruption time is about 350 ms.

Several solutions for reducing the interruption time were discussed during the study item (SI) phase. Solutions 3, 4, and 5 (as disclosed in TR 36.890), and as further described below, are considered to be the solutions that are more relevant. Solution 3 (which is generally applicable to RRC CONNECTED UE) is directed to the provisioning of SC-PTM control information during handover. The provisioned SC-PTM control information may be control information that relates to a neighboring cell. For example, the SC-PTM control information of the target cell may be provided to the UE via a handover command. Thus, a UE may avoid a service interruption that normally results when the UE acquires the SC-PTM control information of the target cell, after handover.

Solution 4 is directed to broadcasting of SC-PTM control information of a neighboring cell. A cell may broadcast the SC-PTM control information that relates to the cell's neighboring cells. As such, solution 4 may eliminate a service interruption that results when the UE acquires the SC-PTM control information of the target cell (after cell reselection or handover occurs).

Solution 5 (which is generally applicable to RRC IDLE UE) is directed to eNB-assisted Radio Resource Control (RRC) connection establishment. The eNB will generally broadcast a trigger criteria (such as, for example, a Reference Signal Received Power (RSRP) or a Reference Signal Received Quality (RSRQ)) to assist the UE in performing the Radio Resource Control (RRC) connection establishment. The eNB may broadcast the trigger criteria when the UE is about to move out of an SC-PTM cell coverage. Subsequently, solution 3 may be applied.

For RRC_CONNECTED UEs, solution 3 is generally considered to be the most suitable solution. For RRC_IDLE UEs, solution 4 or solution 5 may be considered, but solutions 4 and 5 have not yet been evaluated in terms of efficiency and feasibility. The overhead of broadcasting neighbouring cells SC-PTM control information that results from solution 4 has not yet been evaluated.

During the SI phase, there were concerns regarding the radio efficiency and signaling overhead of the previous solutions. Thus, it may be desirable for a new solution to minimize service interruption, while not degrading radio efficiency, and while minimizing the signalling overload.

Use of the previous approaches (such as, for example, Solutions 3, 4, and 5, as disclosed in TR36.890) will generally result in a significant traffic overload on a Uu interface, and, thus, the previous approaches are generally not radio efficient. The current X2 interface exchanges Multimedia Broadcast Multicast Service (MBMS) Service Area Identities (SAI) information, but the current X2 interface does not exchange MBMS service-related information. As described above, when SC-PTM is deployed, an eNB/cell may provide the MBMS service via SC-PTM, but a neighbouring cell may possibly not provide the MBMS service, even if all eNBs belong to a same MBMS Service Area or if they all belong to a same MBSFN area.

In view of the shortcomings of the previous approaches, certain embodiments of the present invention are directed to a method where a network node (such as a base station and/or an eNB) provides a UE with information regarding whether an MBMS service is available in a neighboring cell. Because the information regarding MBMS service availability in the neighboring cell has been provided to the UE, the UE may be able to determine that the neighboring cell does not provide a relevant MBMS service. As such, before the UE moves to the neighboring cell (where the neighboring cell corresponds to a target cell of the UE) or immediately after the UE moves to the neighboring cell, the UE can set up unicast bearer delivery. The event where the UE sets up unicast bearer delivery before the UE moves to the neighboring cell corresponds to the case of proactive UE implementation. In this case, when the UE is expecting to be handed over to a cell, which does not provide the service over SC-PTM, the UE sets up the unicast bearer. The network may decide the target cell. The expected target cell may possibly be different from the actual target cell received in the handover command. The event where the UE sets up unicast bearer delivery immediately after the UE moves to the neighboring cell corresponds to the case of reactive UE implementation. In this case, the UE does not predict a possible target cell. When the UE receives the handover command in the source cell, the UE knows whether or not the target cell provides the service using SC-PTM. In the later case, the UE sets up a unicast bearer as soon as the UE moves to the target cell, with no time wasted on the acquisition of SC-PTM configuration information in the target cell.

Specifically, according to certain embodiments, a first base station may request that a second base station provide information regarding whether certain MBMS services are available to be provided (via SC-PTM) by the second base station. The first base station may start this procedure after the first base station knows that SC-PTM is to be used in the cells of the first base station. For example, the first base station may start this procedure upon the reception of an MBMS SESSION START REQUEST message, where one or more cells of the first base station have been identified as being cells where SC-PTM will be used.

With certain embodiments, the SC-PTM Information Request message may include a list of Temporary Mobile Group Identities (TMGIs) that correspond to MBMS services that the first base station is interested in inquiring about. For example, the MBMS services that correspond to the TMGIs may comprise MBMS services that are currently provided by the first base station via SC-PTM. The MBMS services that correspond to the TMGIs may also correspond to the MBMS services that the UE is interested in utilizing.

With certain embodiments, the SC-PTM Information Request message or part of the message (such as a list of Temporary Mobile Group Identities (TMGIs) that correspond to MBMS services that the first base station is interested in inquiring about) may be included in the Handover Request message, or X2 Setup Request/Response message, or X2 eNB Configuration Update message.

With certain embodiments, the second base station may be configured to provide a response to the first base station, as described in more detail below. The second base station may reply to the first base station regarding whether or not certain MBMS services are available in the second base station via SC-PTM. The availability information may be sent as a list of TMGIs that correspond to the MBMS services that are currently available to be provided by the second base station via SC-PTM. In another embodiment, the availability information may be sent as a bitmap that indicates which of the MBMS services that are requested by the first base station is available to be provided by the second base station.

With certain embodiments, the second base station may report a status update for those MBMS services that were previously indicated by the first base station as being relevant MBMS services. The reporting may report status changes in the relevant MBMS services. For example, in the event that the second base station begins providing a specific MBMS service (via SC-PTM) that was not previously provided by the second base station, this change can be reported by the second base station. Alternatively, in the event that the second base station stops providing an MBMS service that was previously provided by the second base station (via SC-PTM), this change can also be reported.

With certain embodiments, the first base station may inform the UE regarding whether specific MBMS services are provided by neighboring base stations. The first base station can use broadcast signalling or dedicated signalling to inform the UE. The MBMS service availability information could be a list of TMGIs, or the availability information may be in the form of a bitmap that indicates which MBMS services are provided by the neighboring base stations.

In view of the above, certain embodiments may reduce the signalling load that is transmitted over an air interface. Certain embodiments may also be more radio efficient.

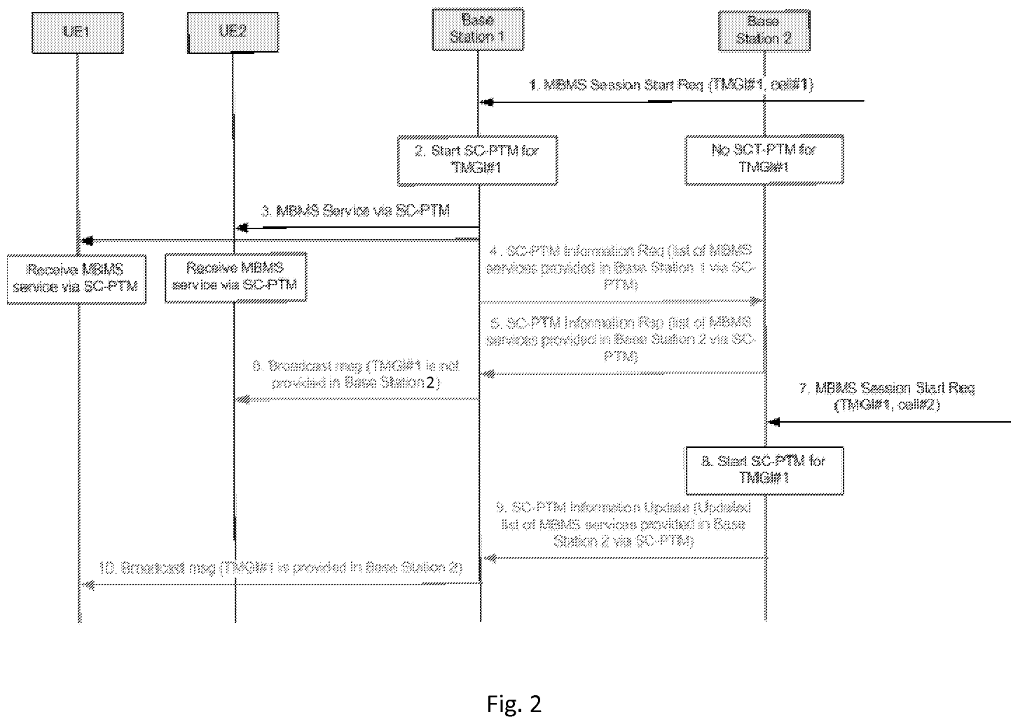

FIG. 2 illustrates an example implementation of certain embodiments of the present invention. Referring to the example implementation of FIG. 2, Base Station 1 and Base Station 2 may be neighbouring base stations. Base station 1 and Base station 2 may belong to a same MBMS Service Area. A specific MBMS service may be provided by Base Station 1, via SC-PTM, but the specific MBMS service may possibly not be provided by Base Station 2. Suppose UE2 is in the process of moving from Base Station 1 to Base Station 2.

Referring to step 1 of FIG. 2, Base Station 1 may receive a request message (such as an MBMS SESSION START REQUEST message), which indicates that an MBMS Service (such as, for example, TMGI#1) is to be provided in cell#1 (a cell of Base Station 1) via SC-PTM. In this example, this MBMS service is not provided by Base Station 2.

Referring to step 2, Base Station 1 starts SC-PTM for TMGI#1. As described above, this MBMS Service is not provided by Base Station 2.

Referring to step 3, UE1 and UE2 receive an MBMS service via SC-PTM.

Referring to step 4, Base Station 1 initiates a request procedure (such as, for example, an SC-PTM Information Request procedure). The SC-PTM Information Request is transmitted from Base Station 1 to Base Station 2. The SC-PTM Information Request may inquire whether certain services are provided via SC-PTM in Base Station 2. The SC-PTM Information Request may include a list of TMGIs, where the TMGIs may identify those MBMS services that are inquired about. The MBMS services that are inquired about may be services that are provided via SC-PTM in Base Station 1. The MBMS services that are inquired about may also correspond to MBMS services that the UEs are interested in using, for example. The list of TMGIs could correspond to the MBMS services on a cell-by-cell basis, in the event that the different cells of Base Station 1 provide different MBMS services.

Referring to step 5, Base Station 2 replies to the SC-PTM Information Request with an SC-PTM Information Response message. The SC-PTM Information Response message may include a list of TMGIs that corresponds to the ongoing MBMS services that are provided via SC-PTM by Base Station 2. The list of TMGIs that is provided by the Base Station 2 could also correspond to the MBMS services for each cell, in the event that the different cells of Base Station 2 provide different MBMS services. Base Station 2 may include additional TMGIs for those MBMS services provided by SC-PTM in Base Station 2, but not required by Base Station 1.

Alternatively, the availability information that is provided by Base Station 2 (in step 5) could be sent in the form of a bitmap, where each bit is related to the TMGI list that is received from Base Station 1 in Step 4. For example, a value “0” within the bitmap may mean that a corresponding TMGI (within the TMGI list that is received from the Base Station 1) is not available in Base Station 2; and value “1” within the bitmap may mean that the corresponding TMGI is available in Base Station 2.

Referring to Step 6, Base Station 1 may use broadcast signalling or may use dedicated signalling to transmit the MBMS service availability information of neighboring cells (such as the cells of Base Station 2). For example, Base station 1 may indicate that an MBMS service (such as, for example, TMGI#1) is not provided by Base Station 2. The information that is sent over the air interface can be a bitmap, for example, where value “0” means that a corresponding TMGI is not available in Base Station 2; and value “1” may mean that the corresponding TMGI is available in Base Station 2. This bitmap can reduce the signalling load that is transmitted over the Uu interface.

Next suppose that UE2 then moves to Base Station 2. Based on the received broadcast signalling or the received dedicated signalling from Base Station 1, UE2 may know that a service (such as TMGI#1, for example) is not provided in Base Station 2. UE2 can choose to initiate unicast delivery before moving to Base Station 2 or immediately after moving (before SC-PTM configuration information acquisition in the cell of Base Station 2) to Base Station 2, thus avoiding an interruption of service.

Referring to Step 7, Base Station 2 may receive an MBMS SESSION START REQUEST message, which indicates that an MBMS Service (such as TMGI#1) is to be provided in cell#2 (of Base Station 2) via SC-PTM. As discussed above, TMGI#1 may be a service which was not previously provided by Base Station 2.

Referring to Step 8, Base Station 2 may start SC-PTM for MBMS service #1.

Referring to Step 9, due to the change in provided service, Base Station 2 may send an SC-PTM Information Update message to Base Station 1. The message indicates that MBMS Service #1 is now provided by Base Station 2 via SC-PTM.

Alternatively, Base Station 2 may initiate a request procedure (such as, for example, an SC-PTM Information Request procedure). The SC-PTM Information Request may include a list of TMGIs, where the TMGIs may identify those MBMS services that are inquired about. The MBMS services that are inquired about may be services that are provided via SC-PTM in Base Station 2, for example, MBMS Service #1. Base Station 1 replies to the SC-PTM Information Request with an SC-PTM Information Response message. The SC-PTM Information Response message may include a list of TMGIs that corresponds to the ongoing MBMS services that are provided via SC-PTM by Base Station 2. Base Station 1 may include additional TMGIs for those MBMS services provided by SC-PTM in Base Station 1, but not required by Base Station 2.

Referring to Step 10, Base Station 1 may report updates via broadcast signalling or via dedicated signalling to indicate whether the MBMS service is available in neighbour cells. For example, Base Station 1 may indicate that TMGI#1 is now provided by Base Station 2. The information that is sent over the air interface can be a bitmap. As described above, this bitmap can reduce the signalling load that is transmitted over the Uu interface.

The SC-PTM Information Request message, SC-PTM Information Response message, and SC-PTM Information Update message may be sent over X2 interface when X2 interface is available between Base Station 1 and Base Station 2, or over S1 interface when no X2 interface is available between Base Station 1 and Base Station 2.

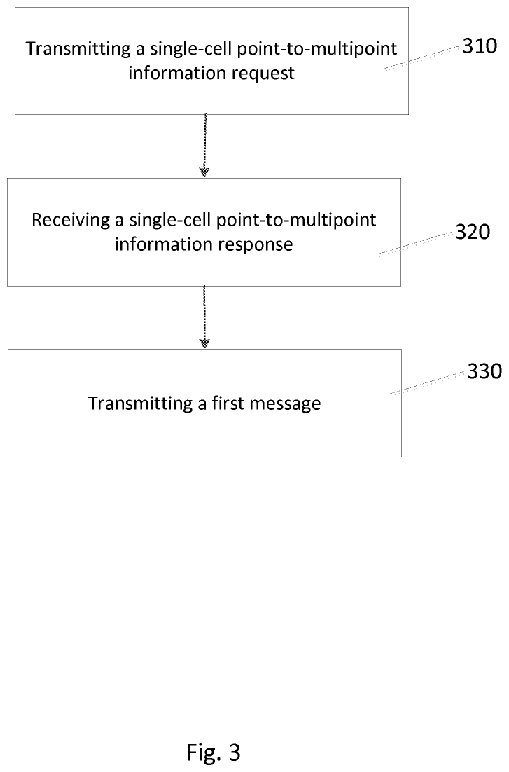

FIG. 3 illustrates a flowchart of a method in accordance with certain embodiments of the invention. The method illustrated in FIG. 3 includes, at 310, transmitting, by a first network node, a single-cell point-to-multipoint information request to a second network node. The single-cell point-to-multipoint information request indicates a first service is provided by the first network node. The method may also include, at 320, receiving a single-cell point-to-multipoint information response. The single-cell point-to-multipoint information response indicates whether the first service is provided by the second network node. The method may also include, at 330, transmitting a first message to user equipment via broadcast or dedicated signaling. The first message indicates to the user equipment whether or not the first service is provided by the second network node.

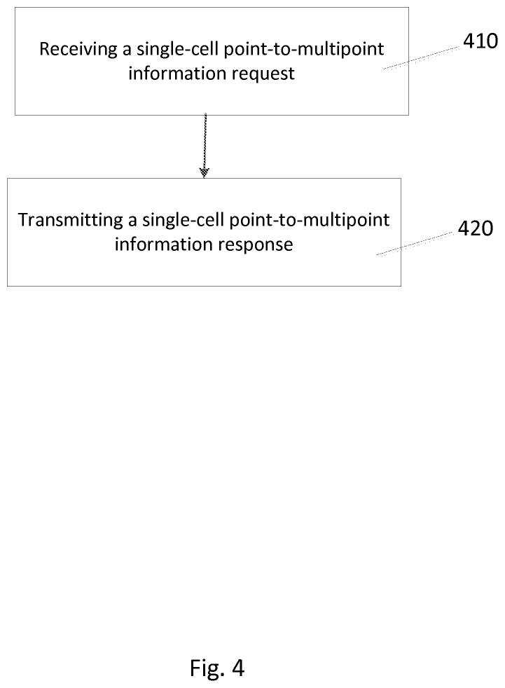

FIG. 4 illustrates a flowchart of a method in accordance with certain embodiments of the invention. The method illustrated in FIG. 4 includes, at 410, receiving, by a second network node, a single-cell point-to-multipoint information request from a first network node. The single-cell point-to-multipoint information request indicates a first service is provided by the first network node. The method may also include, at 420, transmitting a single-cell point-to-multipoint information response. The single-cell point-to-multipoint information response indicates whether the first service is provided by the second network node.

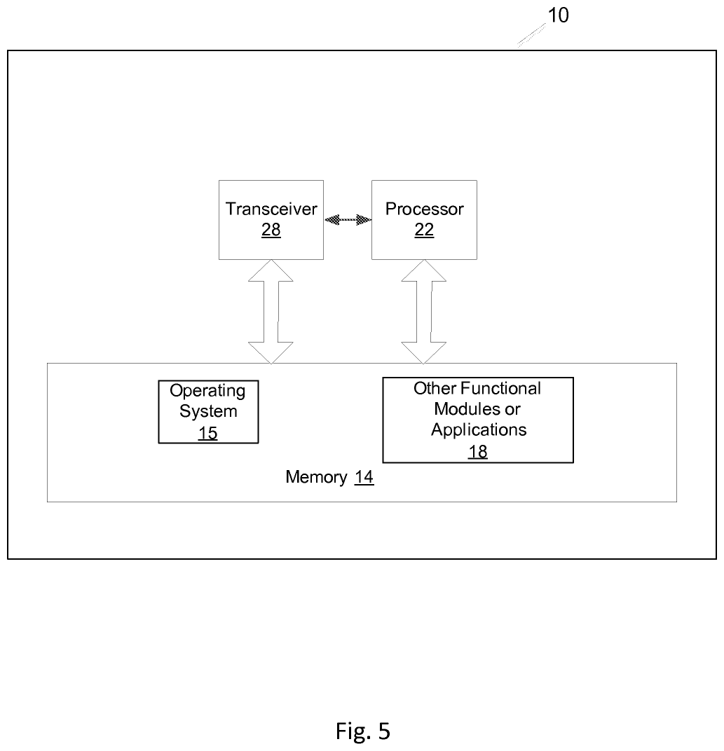

FIG. 5 illustrates an apparatus in accordance with certain embodiments of the invention. In one embodiment, the apparatus can be a network node such as a base station, eNB, and/or a user equipment, for example. Apparatus 10 can include a processor 22 for processing information and executing instructions or operations. Processor 22 can be any type of general or specific purpose processor. While a single processor 22 is shown in FIG. 5, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, preceding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

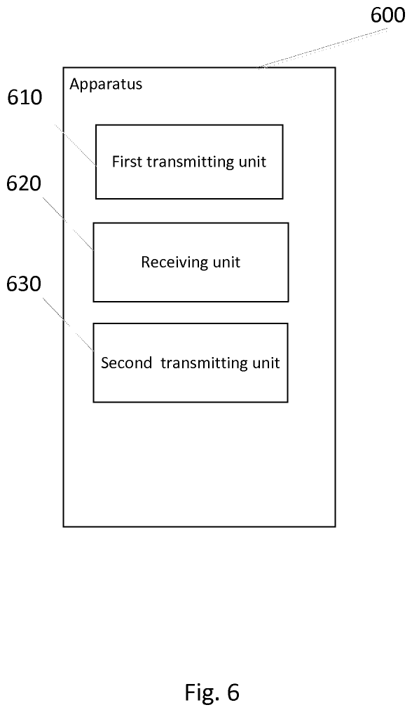

FIG. 6 illustrates an apparatus in accordance with certain embodiments of the invention. Apparatus 600 can be a network node that may be an evolved Node B and/or a base station, for example. Apparatus 600 can include a first transmitting unit 610 that transmits a single-cell point-to-multipoint information request to a network node. The single-cell point-to-multipoint information request indicates a first service is provided by the apparatus 600. Apparatus 600 may also include a receiving unit 620 that receives a single-cell point-to-multipoint information response. The single-cell point-to-multipoint information response indicates whether the first service is provided by the network node. Apparatus 600 may also include a second transmitting unit 630 that transmits a first message to user equipment. The first message indicates to the user equipment whether or not the first service is provided by the network node.

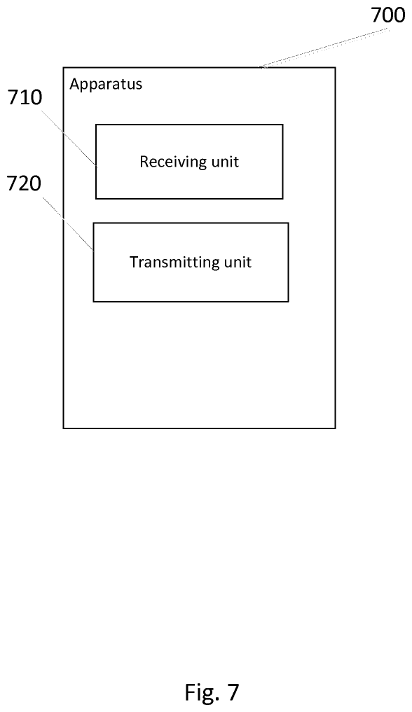

FIG. 7 illustrates an apparatus in accordance with certain embodiments of the invention. Apparatus 700 can be a network node that may be an evolved Node B and/or a base station, for example. Apparatus 700 can include a receiving unit 710 that receives a single-cell point-to-multipoint information request from a network node. The single-cell point-to-multipoint information request indicates a first service is provided by the network node. Apparatus 700 may also include a transmitting unit 720 that transmits a single-cell point-to-multipoint information response. The single-cell point-to-multipoint information response indicates whether the first service is provided by the apparatus 700.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-22. (canceled)

23. A method, comprising:
transmitting, by a first network node, a single-cell point-to-multipoint information request to a second network node, wherein the single-cell point-to-multipoint information request indicates a first service is provided by the first network node;
receiving a single-cell point-to-multipoint information response, wherein the single-cell point-to-multipoint information response indicates whether the first service is provided by the second network node;
transmitting, via broadcast signaling, a first message to user equipment, wherein the first message indicates to the user equipment whether or not the first service is provided by the second network node;
receiving a single-cell point-to-multipoint information update, wherein the single-cell point-to-multipoint information update indicates whether a second service is provided by the second network node; and
transmitting, via broadcast signaling, a second message to the user equipment, wherein the second message indicates to the user equipment whether or not the second service is provided by the second network node.

24. The method according to claim 23, wherein the first network node comprises a first base station, the second network node comprises a second base station, a first cell of the first base station is neighbor to a second cell of the second base station, and the user equipment is in mobility from the first cell to the second cell.

25. The method according to claim 23, wherein the single-cell point-to-multipoint information request, the single-cell point-to-multipoint information response, the single-cell point-to-multipoint information update, the first message, and the second message comprise a list of temporary mobile group identities or a bitmap.

26. The method according to claim 23, wherein the single-cell point-to-multipoint information response indicates whether a third service, which was not indicated in the point-to-multipoint information request as provided by the first network node, is provided by the second network node.

27. An apparatus, comprising:
at least one processor; and
at least one memory including computer program code,
the at least one memory and the computer program code configured, with the at least one processor, to cause the apparatus at least to
transmit a single-cell point-to-multipoint information request to a network node, wherein the single-cell point-to-multipoint information request indicates a first service is provided by the apparatus;
receive a single-cell point-to-multipoint information response, wherein the single-cell point-to-multipoint information response indicates whether the first service is provided by the network node;
transmit, via broadcast signaling, a first message to user equipment, wherein the first message indicates to the user equipment whether or not the first service is provided by the network node;
receive a single-cell point-to-multipoint information update, wherein the single-cell point-to-multipoint information update indicates whether a second service is provided by the network node; and
transmit, via broadcast signaling, a second message to the user equipment, wherein the second message indicates to the user equipment whether or not the second service is provided by the network node.

28. The apparatus according to claim 27, wherein the apparatus comprises a first base station, the network node comprises a second base station, a first cell of the first base station is neighbor to a second cell of the second base station, and the user equipment is in mobility from the first cell to the second cell.

29. The apparatus according to claim 27, wherein the single-cell point-to-multipoint information request, the single-cell point-to-multipoint information response, the single-cell point-to-multipoint information update, the first message, and the second message comprise a list of temporary mobile group identities or a bitmap.

30. The apparatus according to claim 27, wherein the single-cell point-to-multipoint information response indicates whether a third service, which was not indicated in the point-to-multipoint information request as provided by the apparatus, is provided by the network node.

31. A computer program product embodied on a non-transitory computer readable medium, the computer program product configured to control a processor to perform a method according to claim 23.

32. A method, comprising:
receiving, by a second network node, a single-cell point-to-multipoint information request from a first network node, wherein the single-cell point-to-multipoint information request indicates a first service is provided by the first network node;
transmitting a single-cell point-to-multipoint information response, wherein the single-cell point-to-multipoint information response indicates whether the first service is provided by the second network node; and
transmitting a single-cell point-to-multipoint information update, wherein the single-cell point-to-multipoint information update indicates whether a second service is provided by the second network node.

33. The method according to claim 32, wherein the first network node comprises a first base station, the second network node comprises a second base station, a first cell of the first base station is neighbor to a second cell of the second base station, and the user equipment is in mobility from the first cell to the second cell.

34. The method according to claim 32, wherein the single-cell point-to-multipoint information request, the single-cell point-to-multipoint information response, the single-cell point-to-multipoint information update, the first message, and the second message comprise a list of temporary mobile group identities or a bitmap.

35. The method according to claim 32, wherein the single-cell point-to-multipoint information response indicates whether a third service, which was not indicated in the point-to-multipoint information request as provided by the first network node, is provided by the second network node.

36. An apparatus, comprising:
at least one processor; and
at least one memory including computer program code,
the at least one memory and the computer program code configured, with the at least one processor, to cause the apparatus at least to
receive a single-cell point-to-multipoint information request from a network node, wherein the single-cell point-to-multipoint information request indicates a first service is provided by the network node;
transmit a single-cell point-to-multipoint information response, wherein the single-cell point-to-multipoint information response indicates whether the first service is provided by the apparatus; and
transmit a single-cell point-to-multipoint information update, wherein the single-cell point-to-multipoint information update indicates whether a second service is provided by the apparatus.

37. The apparatus according to claim 36, wherein the network node comprises a first base station, the apparatus comprises a second base station, a first cell of the first base station is neighbor to a second cell of the second base station, and the user equipment is in mobility from the first cell to the second cell.

38. The apparatus according to claim 36, wherein the single-cell point-to-multipoint information request, the single-cell point-to-multipoint information response, the single-cell point-to-multipoint information update, the first message, and the second message comprise a list of temporary mobile group identities or a bitmap.

39. The apparatus according to claim 36, wherein the single-cell point-to-multipoint information response indicates whether a third service, which was not indicated in the point-to-multipoint information request as provided by the network node, is provided by the apparatus.

40. A computer program product embodied on a non-transitory computer readable medium, the computer program product configured to control a processor to perform a method according to claim 32.
